(19) United States
(12) Patent Application Publication
(10) Pub. No.: US 2022/0332045 A1
(43) Pub. Date: Oct. 20, 2022

(54) 3D PRINTING PROCESS

(71) Applicant: PDR FLOW LIMITED, Sheffield (GB)

(72) Inventor: Christopher Saywell, Sheffield (GB)

(21) Appl. No.: 17/723,743

(22) Filed: Apr. 19, 2022

(30) Foreign Application Priority Data
Apr. 19, 2021 (GB) 2105587.6

(51) Int. Cl. B29C 64/165; B33Y 10/00; B33Y 70/00; C09D 123/12; C09D 7/20

(52) U.S. Cl. CPC B29C 64/165; B33Y 10/00; B33Y 70/00; C09D 123/12; C09D 7/20; B29K 2023/12

(57) ABSTRACT

A 3D printing process for manufacturing an article, which is a powder bed fusion additive manufacturing process, the process comprising the steps of: (i) provision of a first layer comprising a printing material, said printing material comprising polypropylene in non-nucleated and/or alpha-nucleated form; (ii) the optional provision of a second layer to at least a portion of the first layer; (iii) application of heat to at least a portion of the layer or layers; and (iv) optionally repeating steps (i) to (iii) one or more times; wherein the first layer or the second layer comprises a beta nucleating agent, and wherein the temperature of the printing material is between the melting temperature and the crystallisation temperature of the printing material. Also described is an ink for 3D printing, wherein the 3D printing process is a powder bed fusion additive manufacturing process, the ink comprising a beta nucleating agent, the use of the ink and an article obtained by the process.

### TECHNICAL FIELD

The invention relates to 3D printing processes for manufacturing an article, an article obtainable by such 3D printing processes, an ink for use in said processes, and use of said ink in a 3D printing process.

### BACKGROUND

Powder bed fusion is a type of 3D printing technology (also known as additive manufacturing), which utilises a high-energy source (such as a laser, infrared lamp, or a thermal print head) to selectively melt (or sinter) a layer of a powder bed held on a platform. Similar to other 3D printing techniques, powder bed fusion involves layer-by-layer construction from a digital file. Common examples of powder bed fusion techniques are high speed sintering (HSS), Selective Absorption Fusion™ SAF™, selective heat sintering (SHS), and selective laser sintering (SLS). There are often deficiencies in the ductility and toughness of printed articles prepared via conventional 3D printing processes, for example with powder based materials which are used in powder bed fusion additive manufacturing processes.

Polypropylene is a thermoplastic polymer, which is a member of the polyolefin family. Polypropylene is widely used in injection moulding because of its beneficial properties, such as high chemical resistance, fatigue resistance, and good electrical insulation. However, the use of polypropylene in powder bed fusion processes has typically been hindered by its brittleness and low elongation at break; as demonstrated in [Flores Ituarte, I.; Wiikinkoski, O.; Jansson, A.; Additive Manufacturing of Polypropylene: A Screening Design of Experiment Using Laser-Based Powder Bed Fusion. Polymers 2018, 10, 1293] evaluating various polypropylene polymers in powder bed fusion processes. The current state of the art employs copolymers of propylene with ethylene and/or alpha olefin comonomers which sacrifices tensile strength and stiffness to provide increased elongation at break and/or chain branching is introduced into the copolymer to achieve higher levels of impact strength, tensile strength and stiffness with intermediate levels of elongation at break.

Beta nucleation of polypropylene is a known method for improving the impact performance, fracture resistance and elongation to break over its non- or alpha-nucleated homologues. However, this approach has not been employed in powder bed fusion techniques or for selective deposition processes [Li Z.; Liu C.; Liu H.; Want K. Fu Q.; Non-uniform Dispersion of Toughening Agents and its Influence on the Mechanical Properties of Polypropylene. Express Polymer Letters 2014, 4, 232]. For instance, beta nucleation of powders (via melt compounding) would not be feasible in high speed sintering applications for instance, as beta-nucleated polypropylene possesses a lower melting point, typically around 15° C. lower, compared to the non-nucleated or alpha-nucleated form (for example 150° C. versus 165° C.). A beta-nucleated powder would therefore start to fuse to the build plate in the powder bed, or to itself in the powder bed, or in the recoater during processing, resulting in the article being difficult (or even impossible) to remove, or in poor feature resolution or poor dimensional accuracy of the printed articles.

In view of the beneficial properties of beta-nucleated polypropylene over its non- or alpha-nucleated homologues, it would be advantageous to provide an approach that allows the fabrication of beta crystalline forms of polypropylene in powder bed fusion additive manufacturing techniques.

The invention is intended to overcome, or ameliorate at least, this problem using in-situ beta-nucleation of polypropylene in a 3D printing material within a powder bed fusion additive manufacturing process.

### SUMMARY OF INVENTION

Accordingly, in a first aspect of the invention there is provided, a 3D printing process for manufacturing an article, which is a powder bed fusion additive manufacturing process, the process comprising the steps of:
(i) provision of a first layer comprising a printing material, said printing material comprising polypropylene in non-nucleated and/or alpha-nucleated form;
(ii) the optional provision of a second layer to at least a portion of the first layer;
(iii) application of heat to at least a portion of the layer or layers; and
(iv) optionally repeating steps (i) to (iii) one or more times;
wherein the first layer or the second layer comprises a beta nucleating agent, and wherein the temperature of the printing material is between the melting temperature and the crystallisation temperature of the printing material.

The 3D printing process may further comprise an absorber. Additionally or alternatively, the application of heat to the second layer may comprise the application of heat from a first or a second heat source. In examples where the second layer is present, this may comprise a beta nucleating agent and an absorber; in such examples, the application of heat to the second layer may optionally be from a first heat source. Where the second layer is present and comprises a beta nucleating agent it may be that the application of heat is to at least a portion of the second layer from a second heat source. It may be the case that the first layer additionally comprises a beta nucleating agent; the second layer is present and comprises an absorber; and the application of heat to the second layer is optionally from a first heat source. Alternatively, it may be the case that the first layer additionally comprises a beta nucleating agent; the second layer is absent; and the application of heat is optionally to at least a portion of the first layer from a second heat source.

In a second aspect of the invention there is provided, a 3D printing process for manufacturing an article, the process comprising the steps of: (ia) provision of a first layer comprising a printing material, said printing material comprising polypropylene in non-nucleated and/or alpha-nucleated form; (iia) provision of a second layer to at least a portion of the first layer, the second layer comprising a beta nucleating agent and an absorber; (iiia) application of heat to the second layer from a first heat source; and (iva) optionally repeating steps (ia) to (iiia) one or more times; wherein the temperature of the printing material is between the melting temperature and the crystallisation temperature of the printing material.

Additionally, there is also provided, in a third aspect, a 3D printing process for manufacturing an article, the process comprising the steps of: (ib) provision of a first layer comprising a printing material, said printing material comprising polypropylene in non-nucleated and/or alpha-nucleated form; (iib) provision of a second layer, the second layer comprising a beta nucleating agent; (iiib) application of heat to at least a portion of the second layer from a second heat source; and (ivb) optionally repeating steps (ib) to (iiib) one or more times; wherein that temperature of the printing material is between the melting temperature and the crystallisation temperature of the printing material.

Additionally, there is also provided, in a fourth aspect, a 3D printing process for manufacturing an article, the process comprising the steps of: (ic) provision of a first layer comprising a printing material, said printing material comprising polypropylene in non-nucleated and/or alpha-nucleated form, wherein the printing material further comprises a beta nucleating agent; (iic) provision of a second layer to at least a portion of the first layer, the second layer comprising an absorber; (iiic) application of heat to the second layer from a first heat source; and (ivc) optionally repeating steps (ic) to (iiic) one or more times; wherein that temperature of the printing material is between the melting temperature and the crystallisation temperature of the printing material.

Additionally, there is also provided, in a fifth aspect, a 3D printing process for manufacturing an article, the process comprising the steps of: (id) provision of a first layer comprising a printing material, said printing material comprising polypropylene in non-nucleated and/or alpha-nucleated form, wherein the printing material further comprises a beta nucleating agent; (iid) application of heat to at least a portion of the first layer from a second heat source; and (iiid) optionally repeating steps (id) to (iid) one or more times; wherein the temperature of the printing material is between the melting temperature and the crystallisation temperature of the printing material.

As used herein, “a”, “b”, “c”, and “d” applied in relation to the process steps (i), (ii), (iii) or (iv) relate to a process according to the first to fifth aspects of the invention respectively. Unless otherwise stated herein, any reference herein to any of steps (i), (ii), (iii), (iv) or the like are considered to be equally applicable to all embodiments. For instance, features described with respect to step (i) are considered to applied to any of steps (ia), (ib), (ic) and (id).

As used herein, the term “printing material” relates to the starting material used in a 3D printing process to build up into a 3D printed article. Examples of printing material include thermoplastics, resins, carbon fibres, metals, graphite, and graphene. Typically, the printing material is in the form of a powder.

As used herein, the term “polypropylene” is intended to include “polypropylene-based resins” and “propylene polymers”. The printing material typically comprises greater than 5 wt % of non-nucleated or alpha-nucleated propylene polymer with respect to the total weight of the printing material. More often, the printing material comprises at least 50 wt % non-nucleated or alpha-nucleated propylene polymer, and even more typically at least 60 wt % non-nucleated or alpha-nucleated propylene polymer. In some cases, the printing material comprises at least 90 wt % non-nucleated or alpha-nucleated propylene polymer, and often at least 95 wt % non-nucleated or alpha-nucleated propylene polymer. In addition to the non-nucleated or alpha-nucleated polypropylene polymer, it may be that beta-nucleated polypropylene polymer is also present, such that in some cases any polypropylene polymer that is not non-nucleated or alpha-nucleated is in beta-nucleated form.

Polypropylene may be in the form of a homopolymer. As used herein, the term “homopolymer” relates to a propylene polymer that consists substantially of propylene units. For instance, at least 97 wt %, preferably at least 98 wt % or at least 99 wt %, and still more preferably of at least 99.8 wt % of propylene units. Alternatively, polypropylene may be in the form of, a random copolymer or block copolymer, or a heterophasic copolymer wherein at least 50 mol % of the copolymer is formed from propylene monomers. The heterophasic propylene copolymer may be prepared by any suitable process, including in particular blending processes such as mechanical blending including mixing and melt blending processes and any combinations thereof as well as in-situ blending during the polymerization process. These can be carried out by methods known to the skilled person, including batch processes and continuous processes. Polypropylene in the form of a homopolymer, heterophasic copolymer, a random copolymer or block copolymer may be linear, contain long or short chain branching, and may be partially cross-linked.

Optionally, the heterophasic copolymer, random copolymer or block copolymer is propylene and comonomers selected from olefins having 2 to 10 carbon atoms, such as ethylene, 1-butene, 4-methyl-l-pentene, 1-hexene, dienes, or cyclic olefins, or a mixture thereof. The heterophasic, random or block copolymer may contain up to 50 mol %, and preferably up to 40 mol %, of ethylene or an alpha-olefin having 4 to 12 carbon atoms, or mixtures thereof. Optionally, the homopolymer, heterophasic copolymer, random copolymer or block copolymer may contain other monomers such as maleic anhydride, acrylic acid, glycidyl methacrylate, or siloxane, or silane containing monomers, which are capable of compatibilizing the polymer with other non-polyolefin polymers or fillers.

Optionally, the polypropylene may be a blend of a polypropylene homopolymer or copolymer with one or more different polyolefins, such as ultrahigh molecular weight polyethylene (UHMWPE), cyclic olefin copolymers, polypropylene homopolymers or copolymers grafted with-maleic anhydride, polyethylene grafted with maleic anhydride, high density polyethylene, low density polyethylene, linear low density polyethylene, polyethylene, ethylene vinyl acetate and/or polybutylene.

Blends of propylene homopolymers or propylene copolymers with other polymers, such as polyurethanes, polyesters such as polybutylene terephthalate (PBT), polyester block copolymers, polyamides (such as polyamide 11, polyamide 6, polyamide 6,6, polyamide 12), polyamide block copolymers (such as polyether block amides), fluoropolymers (such as PTFE), polystyrene, polystyrene block copolymers, acrylonitrile butadiene styrene, acrylonitrile styrene acrylonitrile, polyvinylchloride, polymethacrylates, or combinations thereof may be used.

The melt flow rate (MFR) of polypropylene is measured using ASTM-1238 or ISO 1133 or an equivalent method. The MFR of polypropylene should be great enough that it permits the adequate processing of polypropylene in a powder bed fusion additive manufacturing process, but not so great that it results in an undesirable reduction in mechanical properties due to a reduction in the polymer molecular weight. Typically, the MFR is in the range of 1-50 g/10 minutes at 230° C., and more typically in the range of 1-25 g/10 minutes at 230° C. In some instances, lower molecular weight higher MFR polypropylene may be employed as the 3D printing material, provided that they are reacted during the 3D printing process to produce higher molecular weight or cross-linked propylene polymers.

As used herein, the term “first layer” relates to a quantity or thickness of printing material forming the initial layer of said printing material upon which additional layers are built upon. However, as the process is optionally repeated multiple times, the first layer also represents the topmost layer of printing material which is intended to be converted into a new layer of a 3D printed articles. As one skilled in the art would appreciate, 3D printed articles are created through the deposition and selective melting or sintering of multiple layers of material one after another. Often, the thickness of the first layer is less than 10 mm, more typically less than 5 mm, and even more typically less than 2 mm. The thickness of the first layer may be in the range of from about 0.02 mm to 0.1 mm, often in the range of 0.03 mm to 0.09 mm, often in the range of from 0.05 mm to 0.08 mm. The term “second layer” relates to a quantity, or thickness of material added to at least a portion of the first layer. Whilst it is not essential for the second layer to be directly adjacent the first layer, this is usually the case. The second layer typically does not comprise printing material but is provided with compounds and additives helpful in bringing about the melting or sintering of the first layer and subsequent manufacture of multiple additional layers of printed material. Often, the thickness of the second layer is less than 5 mm, more typically less than 2 mm, and even more typically less than 1 mm. It may be the case that the second layer has a thickness in the range 0.5 to 500 μm, often in the range 1 to 100 μm. This may be the case if the second layer is applied as a liquid (for instance via a print head) or as a solid. Generally, it may be the case that where the second layer is applied as a solid (for instance as a powder), the layer thickness would be in the range 20 to 100 μm, often in the range 50 to 80 μm. The thickness of the first layer may be in the range of from about 20 μm to 150 μm, often in the range of 30 to 100 μm, often in the range of 50 to 80 μm.

As used herein, the term “absorber” relates to materials which are capable of absorbing energy and transferring or converting said energy as heat, especially wherein the first heat source is used. For instance, an absorber includes, but is not limited to: infra-red absorbers, UV absorbers or absorbers which absorb light in the visible region. Absorbers or plasmonic resonance absorbers which absorb in the infrared region are particularly preferred. Absorbers which strongly absorb in the visible region include, but are not limited to, carbon black or carbon based additives (for instance, graphene or carbon nanotubes). The absorber can be selected so that it absorbs less strongly in the visible region, enabling the formulation of a non-black, grey, light blue, light green, or off-white 3D printed article; or with the aid of pigments or colouring agents, can produce coloured articles. Non-carbon black absorbers include, but are not limited to: antimony doped tin oxide (ATO) coated particles, typically wherein the particles are barium sulphate or silicone dioxide. Often, the particles have a finer particle size than conventional ATO particles (typically possessing a d₅₀ of around 1.5 μm and d₉₀ of around 3 μm) and may possess a d₅₀ of 0.3-0.5 μm and d₉₀ of less than 1 μm. The finer particle size makes the materials significantly easier to incorporate into inks and possess lower colour than conventional ATO when applied to the surface of the 3D printing powder, both of which are significant technical and commercial advantages in the powder bed fusion process. Commercial antimony doped tin oxide coated materials include Passtran 4410, 8050 and 8080 from Mitsui Kinzoku.

As used herein, the term “beta nucleating agent” is an additive, which is used to modify the crystal structure of polypropylene present in the printing material to seed beta crystals. The term “beta crystals” can also be referred to as “beta-spherulites”, “beta-form spherulites”, or “beta-crystallinity”. The beta nucleating agent includes but is not limited to: the gamma quinacridone (quinacridone pigment red E3B); N,N-dicyclohexyl-2,6-naphthalene dicarboxamide, isophthalic and terephthalic acids; disodium phthalate; a carboxylic acid metal salt of tetrahydrophthalic anhydride, such as barium tetrahydrophthalate, calcium tetrahydrophthalate, magnesium tetrahydrophthalate, strontium tetrahydrophthalate, zinc tetrahydrophthalate and 4-methyl-calcium tetrahydrophthalate; a rare earth metal WBGII with a general formula of CaₓLa₁₋ₓ(LIG1)ₘ(LIG2)ₙ (wherein x is a value less than or equal to 1, more typically less than one, proportional to the amount of Ca²⁺ and La³⁺ ion in the complex; while LIG1 and LIG2 are respectively a dicarboxylic acid and amide-type ligand with coordination numbers of m and n, wherein m and n are integers); 1,4-Dihydroxy-2-sulfoanthraquinone aluminium salt; aluminium salts of 6-quinazirin sulfonic acid; the reaction product of a two-component system of an organic dibasic acid (such as pimelic acid, azelaic acid, o-phthalic acid, terephthalic acid, and isophthalic acid), and an oxide, hydroxide or an acid salt of a metal of Group II (such as magnesium, calcium, strontium, and barium), wherein the acid salt of the second component may be derived from an organic or inorganic acid (such as a carbonate or stearate); pimelic acid calcium salt; and suberic acid calcium salt; calcium salts of phthaloyglycine, hexahydrophthaloyglycine, N-phthaloylalanine and/or N-4-methylphthaloyglycine. Often, the beta nucleating agent is: gamma quinacridone (quinacridone pigment red E3B); 4-methyl-calcium tetrahydrophthalate; calcium tetrahydrophthalate; WBGII rare earth metal complex; pimelic acid calcium salt; isophthalic and terephthalic acids; or disodium phthalate. Most typically, the beta nucleating agent is: gamma quinacridone (quinacridone pigment red E3B); calcium tetrahydrophthalate; WBGII rare earth metal complex; pimelic acid calcium salt; isophthalic and terephthalic acids; or disodium phthalate. The beta nucleating agent may further exhibit alpha-nucleating ability. Different nucleating agents exhibit different nucleation efficiencies. There is no particular limit on the concentration of beta nucleating agent. However typically, the beta nucleating agent is present in a concentration in the range of from 0.05 to 10.0 wt % with respect to the total weight of the ink, often in the range of from 0.06 to 8 wt %, often in the range of 0.07 to 7 wt %, often in the range of 0.08 to 6.5 wt %, often in the range of 0.1 to 6.0 wt % or 0.2-2.0 wt %. However, where the beta nucleating agent is a quinacridone based beta nucleating agent, it is typically present in the range of 0.001 to 1.0 wt % with respect to the total weight of the ink, more typically 0.003 to 0.1 wt %, often in the range of 0.005 to 0.06 wt %, and more often in the range of 0.007 to 0.05 wt %. Quinacridone based beta nucleating agents can be used as pigment additives in higher concentrations, but it has been found as a particularly effective beta nucleating agent when used in these concentrations.

In some embodiments, the beta nucleating agent in the printing material is present in a concentration in the range of from 0.01 to 0.6 wt % with respect to the total weight of the printing material, often in the range of from 0.02 to 0.5 wt %, often in the range of 0.03 to 0.4 wt %, often in the range of 0.05 to 0.4 wt %, often in the range of 0.08 to 0.3 wt %. However, where the beta nucleating agent is a quinacridone based beta nucleating agent, it is typically present in the range of 0.0005 to 0.01 wt % with respect to the total weight of the printing material, more typically 0.0008 to 0.008 wt %, often in the range of 0.0010 to 0.005 wt %, and more often in the range of 0.0012 to 0.003 wt %.

As used herein, the term “first heat source” relates to a device that provides energy such than it is incident upon substantially all of a surface undergoing a 3D printing process. Examples of a first heat source include but are not limited to: a UV lamp; an IR lamp; one or more resistors; or combinations thereof. Typically, the first heat source is an IR lamp.

As used herein, the term “second heat source” relates to a device that provides energy in a targeted fashion to a specific area of a surface undergoing 3D printing. Examples of a second heat source include but is not limited to: a laser; an electromagnetic beam; one or more resistors; or combinations thereof. Typically, the second heat source is a laser, which provides accurate control and precision when applying heat to the build platform.

As one skilled in the art would appreciate, creating complex 3D printed structure in many 3D printing process involves selectively melting, curing, or otherwise changing, a printing material in a particular pattern, which may change with each layer deposition. Accordingly, heat can be provided in a selective fashion in a variety of ways: either by using a targeted heat source; or employing a general heat source which, in combination with particular additives (e.g. absorbers), provides specific heating.

In the process according to invention, the temperature of the printing material is held between the melting temperature and the crystallisation temperature of the printing material, which promotes the formation of beta-polypropylene. Specifically, following the application of heat from the first or second heat source, the polypropylene present within the printing material exposed to the heat source melts. This allows the molten printing material to interact with the beta nucleating agent present in the second layer. During solidification of the molten printing material, beta-polypropylene crystals are formed. Therefore, the heated environment of the 3D printing process enables extended periods of beta polypropylene formation. Such long operational periods are uneconomical in other manufacturing methods, e.g. when injection moulding, extruding or thermoforming.

Without being bound by theory, the inclusion of the beta nucleating agent in the 3D printing process has the ability to increase ductility and toughness in the 3D printed article by various mechanisms including but not limited to: a) generating beta crystallites; b) reducing the crystallite size within polypropylene; c) introducing a secondary or segregated lower melting point within the material during the 3D printing process, such that increased levels of sintering occurs between previously sintered layers and newly sintered layers and/or between individual particles; and d) beta crystallites present in the 3D printed article increasing the weld strength between individual particles and layers, or any combination of these processes.

Moreover, the addition of the beta nucleating agent in the 3D printing process also improves certain other properties in the final article including: improved heat deflection temperature; improved resistance to long-term stress (i.e. long-term hydrostatic pressure); improved weldability and weld strength/durability; reduced weight due to less dense beta crystal form; improved impact resistance; and improved air tightness or reduced porosity of the article.

It is often the case that each subsequent first layer is provided directly adjacent the previous first layer. This has the effect that, during the layer build-up of the 3D printing process, the preceding layer (underlayer) will re-melt more readily upon exposure of the subsequent layer (overlayer) to heat energy, which will lead to improved consolidation and increased mechanical properties in the 3D printed article.

Typically, it may be the case that the beta nucleating agent is provided in the second layer. As such, the beta nucleating agent may be selectively deposited onto the printing material in a separate layer (the first, or often the second layer). By applying the beta nucleating agent in this way it is possible to create patterns of beta nucleating agents so as to not only produce a 3D printed article comprising beta-polypropylene, but one with regions of beta- and non-beta-polypropylene. These regions may be formed from different layers where each layer comprises an even (homogeneous) distribution of beta nucleating agent, or where within any given layer there are regions which contain beta nucleating agent and regions which do not. In view of the differences in thermal and mechanical properties between different types of polypropylene, this approach can create articles with unique properties, and with a precision not possible with known methods. Accordingly, if an absorber is used in tandem with a beta nucleating agent, the absorber and the beta nucleating agent may be applied onto different areas of the first layer of printing material.

Alternatively, or in addition to the above, an alpha-nucleating agent may be applied to prevent the formation of beta-polypropylene. In some embodiments, where a beta nucleating agent is incorporated into the printing material itself, this is particularly preferred. As used herein, the term “alpha-nucleating agent” is an additive, which is used to modify the crystal structure of polypropylene present in the printing material to seed alpha crystals. Examples of alpha-nucleating agents include, but are not limited to: sodium benzoate, the sodium salt of 2,2′-methylene bis(4,6-di-tert-butylphenyl) phosphate, and sorbitol acetal and sorbitol clarifiers. As with the beta nucleating agent, it may be the case that the alpha-nucleating agent is applied such that there are regions of alpha-nucleating agent and regions where this is absent.

As such, there may be provided a 3D printing process, for manufacturing an article, which is a powder bed fusion additive manufacturing process, the process comprising the steps of:
(i) provision of a first layer comprising a printing material, said printing material comprising polypropylene in non-nucleated and/or alpha-nucleated form;
(ii) the provision of a second layer to at least a portion of the first layer;
(iii) application of heat to at least a portion of the layer or layers; and
(iv) optionally repeating steps (i) to (iii) one or more times;
wherein the first and/or second layer comprises regions of beta nucleating agent or alpha nucleating agent which are selectively deposited onto the printing material, and
wherein the temperature of the printing material is between the melting temperature and the crystallisation temperature of the printing material.

This selective deposition of the beta and/or alpha nucleating agents may comprise the formation of regions comprising beta and/or alpha nucleating agent by the selective deposition of layers which comprise the nucleating agents. Additionally or alternatively, this selective deposition of the beta and/or alpha nucleating agents may comprise the formation of regions comprising beta and/or alpha nucleating agent by the selective deposition of beta and/or alpha nucleating agent within one or more layers which layers also comprise regions where the beta and/or alpha nucleating agent are absent.

As such, as also described more generally above, it may be that some of the layers comprise alpha/beta nucleating agent, and some do not. For instance, it may be that not every first layer comprises beta nucleating agent, or that not every first layer comprises alpha-nucleating agent, but that the alpha and/or beta nucleating agents are present in some of the first and/or second layers. This flexibility of provision of the alpha and beta nucleating agents allows for the fabrication of printed articles with a unique blend of crystal properties throughout its architecture such that it is possible to prepare multi-material composite structures in-situ i.e. rigid and impact modified sections within the same part. For instance, it is possible to provide good control of the impact properties and stiffness in specific regions of the printed article, such that this can be tailored for specific uses. Options for this include the provision of stiff support structures, and or high impact resistant outer shells (such as an automotive instrument cluster where a balance of stiffness and impact resistance is advantageous).

It may also be the case that the first and/or second layers are of differing thickness, as this may benefit the impact resistance or stiffness of the final printed article.

Optionally, the second layer is applied via a print-head. Examples of the print-head include, but are not limited to, drop-on-demand (DOD) ink-jet print-heads such as thermal print-heads, and piezoelectric print-heads; or continuous ink-jet print-heads. Application via a print-head is beneficial as it provides for the specific location and concentration of the beta nucleating agent and/or absorber onto a first layer of printing material. One or more print-heads, or print-heads containing multiple channels, can also be used. For instance, multiple print-heads could be used to provide for selective deposition of areas with alpha-nucleators, beta-nucleators, or no nucleators for example. This approach can create articles with unique properties.

It may be the case that the second layer is provided as an ink. As used herein, the term “ink” relates to any functional substance or material suited for processes of the invention which is capable of being printed. The ink acts as a carrier for the beta nucleating agent, the absorber, and/or any other additives present therein. An ink is easily applied via a print-head, and having the second layer provided as an ink allows for a high level of control in the concentration and specific location of materials to the first layer of printing material.

Where the second layer is applied via a print-head, certain features of the print-head can be utilised which enable the volume of ink which is deposited in a specific area of the first layer of printing material to be varied and therefore the amount of beta nucleating agent which is deposited on the first layer to be varied. This provides for easy control of the ratio of ink to powder. For example, a drop-on-demand printhead allows for the creation of a range of drop sizes which varies the picolitre volume of ink deposited and therefore the amount of beta nucleating agent which is deposited in a given area of the first layer. The variation of drop size and picolitre volume is sometimes referred to as “grey-scale printing”. Alternatively, the spatial coverage of the drops can be varied through dithering, spatial dithering, screening or halftoning. Varying the volume of ink deposited within different sections of printed articles will vary the concentration of beta nucleating agent deposited within different sections of a printed article enabling the creation of a printed article with unique properties.

The ink may comprise a solvent selected from an oleophobic liquid, or an oleophilic liquid. There is no particular limitation on the choice of solvent and, as one skilled in the art would appreciate, the selection of the solvent depends on the additives conveyed in the ink and the desired property profile of the 3D printed article.

Oleophobic solvents are typically polar, non-plasticising, and do not have a diluent effect with regards to polypropylene. A non-limiting example of an oleophobic solvent are polar solvents such as water or alcohols. Often, the oleophobic solvent will be water.

Oleophilic solvents are typically non-polar and are capable of interacting with the polymer and can have a plasticising or diluent effect with regards to polypropylene, which can further increase the toughness and ductility of the 3D printed article. Examples of oleophilic liquids include, but are not limited to: hydrocarbons, such as high-purity synthetic isoparaffins (for instance, Isopar™ C, E, G and H by ExxonMobil). Hydrocarbons in particular are suitable for formulating ink-jet inks due to their controlled manufacturing process and viscosity profiles. In addition, they have also been found to increase certain properties of propylene polymers (i.e. increased impact resistance and elongation at break) in powder bed fusion processes whilst reducing other properties (tensile strength and stiffness). Moreover, hydrocarbons are also acceptable solvents for many of the additives disclosed herein.

Optionally, the printing material further comprises one or more additives selected from: a non-propylene polymer; a compatibilizer; a stabiliser; an acid scavenger; an oxygen scavenger; a moisture scavenger; a pigment; a colourant; a fragrance; a flame retardant; an antimicrobial, antifungal or antifouling agent; an antistatic agent; a magnetic agent; an electromagnetic shielding agent; a radio-opaque agent; a conductive agent; a cross-linking agent; a foaming agent; a flow aid; a reinforcing filler; a plasticiser; or combinations thereof.

Non-propylene polymers which may be added to the 3D printing material may include one or more different polyolefins, such as ultrahigh molecular weight polyethylene (UHMWPE), cyclic olefin copolymers, high density polyethylene, low density polyethylene, linear low density polyethylene, polyethylene, ethylene vinyl acetate and polybutylene or other polymers such as polyurethanes, polyesters such as polybutylene terephthalate (PBT), polyester block copolymers, polyamides (such as polyamide 11, polyamide 6, polyamide 6,6, polyamide 12), polyamide block copolymers (such as polyether block amides), fluoropolymers (such as PTFE), polystyrene, polystyrene block copolymers, acrylonitrile butadiene styrene, acrylonitrile styrene acrylonitrile, polyvinylchloride, polymethacrylates, or combinations thereof may be used.

As used herein, the term “Flow aid”, which includes anti-caking additives and rheological agents, relates to additives that may be added to the 3D printing material to improve the flowability and coatability of the powder within the powder bed fusion process and to increase powder packing density. Flow aid(s) may be particularly beneficial when the 3D printing material contains particles less than 25 micron or irregular shaped particles. Flow aid(s) improve the flowability of the 3D printing material by reducing the friction, the lateral drag, and the tribocharge build up (by increasing the particle conductivity). Examples of suitable flow aids include, but are not limited to, tricalcium phosphate (E341), sodium silicate (E550), silicon dioxide (E551), calcium silicate (E552), magnesium trisilicate (E553a), sodium aluminosilicate (E554), potassium aluminium silicate (E555), calcium aluminosilicate (E556), bentonite (E558), aluminium silicate (E559), and stearic acid (E570); particularly preferred flow agents for the 3D printing material are synthetic amorphous silicon dioxides and in-particular hydrophobically treated fumed silicas and hydrophobically treated precipitated silicas such as those sold by Evonik Industries AG under the trade-names AEROSIL® and SIPERNAT®. The flow aid may be added in the range of approximately 0 wt % to 5 wt % and more preferably in the range 0 wt % to 0.5 wt %.

Optionally, the ink may comprise at least one additive selected from: an absorber; a stabiliser; an acid scavenger; a reinforcing filler; a compatibilizer; an oxygen scavenger; a moisture scavenger; a pigment or colourant; a dispersant; a plasticiser; a fragrance; an alpha-nucleating agent; a flame retardant; an antimicrobial or antifouling agent; an antistatic agent; a magnetic agent; an electromagnetic shielding agent; a radio-opaque agent; a conductive agent; a cross-linking agent; a foaming agent; an adjuvant to any of the above; or combinations thereof. In addition, the ink may comprise an agent capable of modifying the molecular weight distribution of the polymer. It may be the case that, when the ink comprises polypropylene, the polypropylene may comprise at least one of the above mentioned additives, or combinations thereof.

As used herein, the term “UV stabiliser” relates to additives which prevent UV degradation of the printed article. Examples of UV stabilisers include, but are not limited to: hindered amine light stabilisers (HALS) in solid or liquid form, and in both high molecular weight and low molecular weight varieties. Optionally, the ink is formulated with a combination of high and low molecular weight stabilisers to give long term UV and outdoor ageing stability. Optionally, the UV stabilisers are dissolved or solubilised in the ink solvent rather than dispersed (insoluble), so that when the ink is deposited onto the 3D printing material the UV stabilisers can be combined effectively with the 3D printing material. HALS which have higher solubility values in n-hexane (g/100 g solvent), are preferred because they are soluble in isoparaffin (as discussed above as one of the possible solvents which can be present in the ink). Therefore, HALS are able to form stable inks and are more stable to temperature cycling between ambient and sub-zero temperatures (around 22° C. and −15° C.) without excessive precipitation or gelling occurring. HALS with n-hexane solubility values>4 g/100 g solvent are particularly preferred. Commercial examples of such HALS include, but are not limited to: Tinuvin 770 (CAS 52829-07-9), Chimasorb 944 (CAS 70624-18-9), and Tinuvin 292 (CAS 1065336-91-5 (41556-26-7 and 8291937-7). Chimasorb 944 is a particularly preferred. Substituted benzotriazoles, benzophenones and hydroxybenzoates can also be used as UV stabilisers. Again, those with higher solubilities in n-hexane (>4 g/100 g) are preferred. Commercial examples of such species include 2-(2′-hydroxy-3′,5′-di-tert amylphenyl)benzotriazole (CAS 25973-55-1), SONGSORB® 3280; 2-hydroxy-4-n-octoxybenzophenone (CAS 1843-05-6), SONGSORB® 8100; Hexadecyl-3,5-di-tert-butyl-4-hydroxybenzoate (CAS 67845-93-6), SONGSORB® 2908.

As used herein, a “thermal stabiliser” refers to an additive, which is able to prevent the negative effects of heat during processing or the article, or during use of the article. Typically, thermal stabilisers which are soluble in the ink or thermal stabilisers which melt between the crystallisation and melting temperature of the polymer are selected, so that they are readily combined with polypropylene present in the 3D printing material when applied. In this case, it is not required that the 3D printing material melts in order to allow for combination of the thermal stabiliser with the 3D printing material. Typically, the thermal stabilisers are selected from a primary phenolic thermal stabiliser or a secondary phosphite thermal stabiliser, or combinations thereof. Examples of suitable primary phenolic thermal stabilisers include, but are not limited to: 3,5-Bis(1,1-dimethylethyl)-4-hydroxy-benzenepropanoic acid (Anox 1315) and Pentaerythritol tetrakis(3-(3,5-di-tert-butyl-4-hydroxyphenyl)propionate) (Irganox 1010) (melting point 110-125° C.). Examples of suitable secondary phosphite thermal stabilisers include but are not limited to nonylphenol-free phosphite antioxidants such as Weston 705, and phosphorus based secondary antioxidants such as Hostanox PEPQ (melting point 85-95° C.).

Additionally, certain sulphur containing thiosynergist additives can be used in certain applications, such as automotive under bonnet component manufacture, to enhance the long-term thermal stability of said component. However, such additives are not suitable for automotive interior applications because they can have an undesirable odour, or breach limits for volatiles in such applications. As such, it is preferable to add a thiosynergist additive during the 3D printing process only for the applications and articles which require or permit a thiosynergist additive. A preferred thiosynergist additive is liquid thiosynergist Dilauryl thiodipropionate (CAS 10595-72-9; Songnox L226), because it has good solubility in n-hexane and in isoparaffinic solvent.

Most typically, the powdered propylene copolymer will already be in a stabilised form with primary and secondary phenolic and phosphite based thermal stabilisers. However, in certain instances polymers in fine powder form are available in an unstabilised form. In the case of propylene polymers, these will often require the addition of thermal stabilisers and acid scavengers in order to optimise them for use in a 3D printing processes. In this instance, thermal stabilisers may be included within the ink to facilitate the ready use of these unstabilised powders in the powder bed fusion process.

As used herein, the term “acid scavenger” relates to additives which remove acidic catalyst residues in propylene polymers. There is no particular limitation on the choice of acid scavenger but typically the acid scavenger is selected from: calcium stearate, glycerol monostearate or synthetic hydrotalcites, or combinations thereof. Particularly preferred acid scavengers are synthetic hydrotalcites. Acid scavengers which are soluble in the ink include zinc-2-ethyl-hexanoate.

In certain instances, polymers in fine powder form are available in an unstabilised form and in the case of propylene polymers these may require the addition of thermal stabilisers and/or acid scavengers in order to optimise them for use in a 3D printing processes. Acid scavengers may be included within the ink to assist the use of these unstabilised printing materials.

As used herein, the term “reinforcing filler” relates to materials added to the 3D printing material or ink to help reduce the density and weight of the 3D printed article, or alter specific properties, such as increased stiffness, enhanced wear resistance or reduced warpage. Reinforcing fillers which have weak or low nucleating ability in propylene polymers are preferred, so that they do not significantly compete with, or override, the effect of the beta nucleating additives. Examples of suitable reinforcing fillers include, but are not limited to: nano-calcium carbonate, synthetic hydrotalcites, silicas, silicates, graphene and graphene oxide, graphite, hexagonal boron nitride, glasses (e.g. glass beads, hollow glass spheres, glass fibres or glass flakes), carbon nanotubes or carbon fibres, halloysite nanotubes, wollastonite, synthetic polymer fibres (such as polyaramid fibres e.g. Kevlar®) or natural fibres, metal powders or metal fibres, aluminium oxides, or titinates. Most preferred are nano calcium carbonates and synthetic hydrotalcites.

When the reinforcing filler is a metal powder, metal fibre, or a glass, it may be the case that the reinforcing filler is also surface treated. For example, when the reinforcing filler is a glass, it may undergo siloxane or silane surface treatment prior to incorporation into the 3D printing material or the ink.

Optionally, reinforcing fillers of around less than 2 μm, in one or more geometries, are incorporated, so that they are easily jettable through an ink-jet print head and so that settling of the reinforcing filler within the ink is minimised. Reinforcing fillers which have weak or low nucleating ability in propylene copolymers are preferred, so that they do not significantly compete with, or override, the effect of the beta nucleating additives in the ink or the printing material.

As used herein, the term “compatibilizer” relates to additives that improve the thermal, mechanical and/or dimensional stability of the 3D printed article by compatibilizing two or more phases or components within a mixture. An Example of a compatibilizer includes, but is not limited to, a maleic anhydride modified polyolefin, such as a polypropylene grafted with maleic anhydride.

Optionally, the printing material is dry blended with a reinforcing filler. Typically, a liquid ink containing a beta nucleating agent is jetted onto the printing material during the printing process via a print-head. As used herein, the term “dry blended” relates to instances where the printing material is not melt compounded or combined in liquid form with the additive in question prior to grinding or formation of a powder. When the ink is applied, it is able to coat the printing material but also the outside of the reinforcing filler, which improves the ductility of the interface between the reinforcing filler and the printing material when it is consolidated via melting. This enables a better balance of mechanical properties (for instance, increased stiffness without a detrimental loss of article ductility or impact resistance). The coating of fillers may also override the alpha-nucleating ability of certain fillers (such as talc) allowing them to still be used and ensure beta nucleation is achieved in the final article. In particular, when glass beads or fibres are incorporated into the printing material, there is a significant improvement in the toughness and stiffness of such glass bead or fibre reinforced polypropylene composites.

As used herein, the term “pigment” or “colourant” relates to additives added to the ink or the printing material to provide the printed article with a specific colour, or to provide other functional benefits. For example, where a printing material contains an absorber which is not strongly absorbing in the visible region (such as antimony doped tin oxide coated particles), coloured printed articles can be prepared by the addition of pigments. However, certain pigments have an alpha-nucleating effect on propylene polymers, and may reduce the beta nucleating agent's efficacy. Typically, pigments which have a weak nucleating effect on propylene polymers are used. A range of blue and yellow pigments which can be combined with beta nucleating agents are described in patent WO 2009/092700 A1. In some cases, the beta nucleating agent used can provide pigmentation while retaining their beta nucleating ability. For instance, where the beta nucleating agent is a quinacridone pigment (such as pigment red E3B). However, when used as a pigment, a quinacridone based beta nucleating agent is often present in the range of 0.1 to 10.0 wt % with respect to the total weight of the ink

As used herein, the term “dispersant” relates to an additive used to enhance the dispersion of the beta nucleating agent in the ink or the printing material. There is no particular restriction as to which dispersant is employed and it may be that the dispersants included are selected from those that do not modify the chemical structure of the beta nucleating agent. For instance, the dispersant may be a dispersant that provides beta nucleating agent stability by steric hinderance stabilization, such as Solsperse® hyperdispersants (manufactured by Lubrizol®).

As used herein, the term “plasticiser” relates to an additive which when added above a certain threshold makes the printing material more flexible, reduces modulus and tensile strength and may increase elongation. The additive may also reduce the glass transition temperature (Tg) of the printing material and have a toughening effect on the printing material. The degree of change in these properties is a function of both plasticiser type and its concentration. The additive may enter both the crystalline (ordered) and the amorphous (disordered) regions of a semi-crystalline polymer, such additives being referred to as primary plasticisers. Or the additive may only enter the amorphous regions, such compounds may be considered as secondary plasticisers. Examples of plasticisers include but are not limited to linear hydrocarbons such as isoparaffins (for instance, Isopar® C, E, G and H by ExxonMobil®), low molecular weight ethylene α-olefin copolymers, atactic polypropylene, ortho phthalate ester plasticisers such as dioctyl and dibutyl phthalate, vegetable oil-based compounds such as soybean or linseed oil, including epoxidised, hydrogenated and acetylated vegetable oils

As used herein, the term “oxygen scavenger” relates to an additive used to help remove or decrease the level of reactive oxygen species. This can extend the shelf-life of the printed article. Whilst there is no particular limitation on the choice of oxygen scavenger, typical examples of oxygen scavengers are iron oxide based oxygen scavengers.

As used herein, the term “flame retardant” relates to additives added to prevent or suppress combustion of the printed article. Typically, flame retardants which can have an effect at low levels in the printing material are selected. Such agents can be incorporated within the ink and provide an uplift in the fire performance of the article. Examples of flame retardants include but are not limited to halogenated flame retardants and non-halogenated flame retardants (such as, ADK STAB FP-T80). Halogenated flame retardants can be used at low levels, and non-halogenated flame retardants are environmentally friendly.

As used herein, the term “antimicrobial agent” relates to additives which render a printed article resistance to microbial growth, and the term “antifouling agent” refers to additives which protect the printed article from biofouling. Both antimicrobial agents and antifouling agents may be effective against: fungi, bacteria, virus, and/or other such pathogens.

Examples of antimicrobial agents include but are not limited to silver or zinc based additives with broad antimicrobial and antifungal activity.

Antimicrobial or antifouling additives may be supported within a zeolite or silica carrier with a particle size of around less than 2 μm. Incorporating the antimicrobial or antifouling additive within the ink allows for it to be placed at the surface of an article where it is often desired, which reduces the overall cost, the amount of active required, and can also increase efficacy of the additive. Accordingly, not all additives need be provided in the ink for every step of the process of the invention.

As used herein, the term “antistatic agent” relates to additives that lower the resistivity of the printed article. Both non-migratory (internal) and migratory antistatic agents may be incorporated within the ink or printing material. Examples of non-migratory (internal) antistatic agents include but are not limited to conductive carbon, graphene oxide, metal fillers, metal oxides or metal nanoparticles (such as copper, silver, and gold), and ionic polymer based additives. Examples of migratory antistatic agents include, but are not limited to: glycerol monostearate, ethoxylated fatty acids, ethoxylated fatty acid amines and diethanolamides. The incorporation of the additive within the ink allows for it to be placed at the surface of the article, where it is often desired, which reduces the overall cost, the amount of active required, and can also increase efficacy of the additive.

As used herein, a “magnetic agent” relates to additives which enhance the magnetic properties of the 3D printed article. A non-limiting example of a magnetic agent is nanoparticulate iron oxide (Fe₃O₄).

As used herein, the term “cross-linking agent” relates to additives that introduce chain branching and cross-linking within the printing material to increase properties including modulus, stiffness and heat resistance. Examples of cross-linking agents include, but are not limited to: multifunctional acrylate additives (such as 1,6-hexanediol diacrylate, or tri- and tetra-functional acrylates), or peroxides (such as dicumyl peroxide). The incorporation of the cross-linking agent within the ink allows for more control of its application, as it enables of the additive to be placed in specific regions of the printed article where desired.

During the 3D printing process, the temperature of the printing material may be in the range of 100° C. to 140° C. This is the optimum temperature range for promotion of melting and crystallisation of polypropylene and, in combination with the first or second heat source, allows the formation of high concentrations of beta crystallites in the article in desired regions. Typically, the temperature is maintained within the described range for a period of greater than one minute, preferably greater than 5 minutes, and more preferably greater than 15 minutes to ensure optimum formation of beta crystallites in the article.

The 3D printing process may further comprise the additional step of recycling unmelted printing material. As one skilled in the art will appreciate, those regions of the first layer not exposed to effective heating from the first or second heat source will remain substantially unmelted, substantially retaining their original crystal form. This material can be redeployed in subsequent deposition steps. This reduces the level of waste material, which is both environmentally and economically beneficial.

The additional step of recycling the unmelted printing material may comprise cooling the printing material. This additional cooling step ensures that substantial beta nucleation does not occur within the unmelted printing material.

The 3D printing process may further comprise a step of removing the article from the printing material. This additional step may involve cooling the article.

The article may be a) cooled when it is still within the 3D printing material i.e. before removing the article from the printing material so that the article and powder are cooled together or b) cooled by removing the article from the printing material while both are still warm. Typically, the article would be cooled before it is removed from the printing material so that the article and 3D printing material cool down slowly together so as to prevent warping of the article. It may be the case that active cooling is employed. The term “active cooling” refers to situations wherein the cooling of the printed article is accelerated by exposing the part to a coolant or cooling element as compared to passively allowing the printed articles to cool by discontinuing the provision of heat. A typical rate of cooling achieved with active cooling is greater than or equal to 0.15° C. per minute. A typical method for promoting active cooling is to draw air through the powder bed. Active cooling could also constitute removal of the article from the printing material whilst it is still warm but below its crystallization temperature and allowing the article to cool in air or other coolant material. However, this is less preferred due to the potential for warping of the article as it cools. Typically, “passive cooling” refers to situations wherein the printed article is allowed to cool when still contained in the 3D printing material. This may be inside the powder bed fusion machine or outside of the powder bed fusion machine in a block or cake of powder. Typically, a passive or natural cooling time is approximately four times longer than the printing time. Typically, active cooling reduces the time for removing the article from the printing material by greater than or equal to one hour compared to the passive or natural cooling time. Active cooling at the end of the 3D printing process curtails any further crystallisation processes and so prevents a reduction in the fidelity of crystal structure imbued by the 3D printing process.

In the 3D printing process, the printing material is a powder. Typically, when the printing material is a powder, the 3D printing process is a powder bed fusion additive manufacturing process. Examples of powder bed fusion additive manufacturing processes include but are not limited to high speed sintering (HSS), Selective Absorption Fusion™ SAF™, multi jet fusion (MJF), laser sintering (LS), there is no particular limitation on the particle size or the particle size distribution of the powder. However, typically, the particle size distribution will be in the nanometre or micrometre range i.e. typically in the range of 1 μm to 500 μm, more typically 1 μm to 150 μm. Often, the particle sizes of the powder will have a Gaussian distribution.

According to the invention, it may be the case that particles of printing material comprising polypropylene in the powder are coated with a beta nucleating agent. Alternatively, the beta nucleating agent may be included together with the printing material as free beta nucleating agent, as an encapsulated or coated form of the beta nucleating agent i.e. coated in a thermoplastic polymer, or alternatively may be homogenised with the printing material such that the particles of the powder comprise a substantially homogenous mixture of both printing material and beta nucleating agent.

The beta nucleating agent(s) may be applied via an ink. In particular, this is often the case where the 3D printing process is a high speed sintering, Selective Absorption Fusion™ SAF™ or multi-jet fusion process.

In the 3D process, the use of a beta nucleating agent can have advantages in post processing of the article. Polypropylene is a material which is difficult to solvent vapour smooth due to its high level of solvent resistance. Solvent vapour smoothing is a commonly used method to post process printed articles in order to reduce their surface roughness, seal the surface of articles, and improve mechanical properties. A beta-nucleated printed article is rendered more suitable to a thermal post processing stage (typically under isostatic pressure), which can be used to densify the part and the surface of the article whilst maintaining the structural and dimensional tolerances of the article to within acceptable levels due to the lower melting point of the beta crystallites within the printed article.

For instance, if the beta nucleating agent is only applied to the external surfaces of printed articles, the external surface of the article can be selectively melted at temperatures around 15° C. below the melting temperature of the bulk article, which would allow the article to be smoothed whilst retaining its structural integrity. The heating process in the post processing of a printed article could be performed in a controlled heated environment such as an oven. Alternatively, hot isostatic pressing (HIP), where pressure is applied via gas pressure uniformly to all surfaces of the article at an elevated temperature, may also be employed to aid in the smoothing and consolidation of the printed article.

Also, when an article comprising polypropylene is beta-nucleated through its entirety and post processed via hot isostatic pressing at a temperature which is selective for melting of the beta phase then this process may result in improved powder consolidation leading to increased density, reduced porosity and increased mechanical properties of the printed article whilst retaining the shape and dimensions of the original printed article.

The printing process according to the fourth and fifth aspects of the invention may comprise the step of preparing the printing material, wherein the beta nucleating agent is dispersed throughout the polypropylene in non-nucleated and/or alpha-nucleated form. For instance, it may be the case that the beta nucleating agent is dispersed within the printing material by dry blending for instance the beta nucleating agent may coat the outside of the printing material or be included together with the printing material as free beta nucleating agent or may be dispersed as an encapsulated or coated form of the beta nucleating agent. Alternatively, the beta nucleating agent may be dispersed in the printing material during the polymerisation stage of polypropylene. Further, the beta nucleating agent may be dispersed by melt extrusion methods into a carrier to make a concentrated masterbatch which can then be diluted by melt extrusion into the printing material before it is converted into a powder suitable for powder bed fusion. Alternatively, the beta nucleating agent may be dispersed by melt-extrusion methods directly in the printing material before the printing material is converted into a powder suitable for powder bed fusion.

Optionally, the step of preparing the printing material comprises cooling the printing material. This additional cooling step ensures that substantial beta nucleation does not occur within the printing material, and that the broad processing window required for powder bed fusion 3D printing processes is maintained.

There is also provided according to a sixth aspect an ink for 3D printing, the ink comprising a beta nucleating agent. The beta nucleating agent may be provided as particles, the particles may have a particle size of less than or equal to 150 μm more typically less than 5 μm and most typically less than 3 μm (such as in the range 0.1 μm-150 μm, or 0.5 μm-5 μm or often 1 μm-3 μm. A beta nucleating agent of such a particle size is more easily dispersed within the ink, and therefore provides enhanced beta nucleation.

Optionally, the ink may be a liquid. The liquid ink is typically applied to a printing material during the 3D printing process via any suitable method including spraying, coating, jetting, dropping, dripping, or more preferably, via a print-head. The liquid ink may comprise a solvent selected from an oleophobic liquid, or an oleophilic liquid. The selection of the solvent depends on the desired property profile of the printed article comprising polypropylene.

Oleophobic solvents are neutral, non-plasticising, and do not have a diluent effect. A non-limiting example of an oleophobic liquid is water.

Oleophilic solvents capable of interacting with the polymer, with a plasticising or diluent effect, can further increase the toughness and ductility of the 3D printed article. Examples of oleophilic liquids include but are not limited to a hydrocarbons, such as high-purity synthetic isoparaffins (for instance, Isopar® C, E, G and H by ExxonMobil®). Hydrocarbons in particular are suitable for formulating ink-jet inks due to their controlled manufacturing process and viscosity profiles. In addition, they have also been found to increase certain properties of propylene polymers (i.e. increased impact resistance and elongation at break) in powder bed fusion processes whilst reducing other properties (tensile strength and stiffness). Moreover, hydrocarbons are also acceptable solvents for all additives disclosed herein.

Optionally, the beta nucleating agent may be milled and dispersed within the solvent, and the particle size of the beta nucleating agent following this process may be in the range of 30 nm-2000 nm. This particle size range is particularly effective when the ink is applied via a print-head.

Alternatively, according to another embodiment, the ink may be a solid. When the ink is provided as a solid, it may be in the form of a powder, granules, or pellets, or combinations thereof. The powder, granules, or pellets may have a size of less than or equal to 5 mm for pellets, and less than or equal to 150 μm for powders.

Provision of an ink as a powder, granules or pellets allows for even distribution of the beta nucleating agent within said ink. The beta nucleating agent may be dispersed within the solid ink using conventional melt blending or extrusion methods, dry blending, high shear mixing, or via a fluidised bed mixing process.

Optionally, when the ink is provided as a solid, it may comprise polypropylene. When the ink comprises polypropylene, it ensures high compatibility with the printing material, and enhanced beta nucleation within the printed article. In such situations, when melt blending or extrusion methods are used to add beta nucleating agent, the ink may be quench cooled (for example by chilled water cooling or another cooling medium), such that substantial beta nucleation does not occur within the ink.

Optionally, when the ink is provided as a solid, it may be deposited selectively with respect to the first layer for example as a pattern onto the surface of the first layer or it may not be deposited in combination with every first layer.

As above for the earlier aspects of the invention, the ink according to the sixth aspect of the invention may further comprise at least one additive selected from: an absorber; a stabiliser; an acid scavenger; a reinforcing filler; a compatibilizer; an oxygen scavenger; a moisture scavenger; a pigment; a colourant; a dispersant; a plasticiser; a fragrance; an alpha-nucleating agent; a flame retardant; an antimicrobial, antifungal or antifouling agent; a static dissipative agent; a magnetic agent; an electromagnetic shielding agent; a radio-opaque agent; a conductive agent; a cross-linking agent; a foaming agent; an adjuvant to any of the above; or combinations thereof.

There is also provided in a seventh aspect of the invention, the use of an ink according to the sixth aspect of the invention in a 3D printing process. Use of the ink results in the introduction of a lower melting, beta-nucleated, polypropylene in a sintered layer of printing material. As such, this layer will re-melt more readily upon exposure to heat energy, resulting in improved consolidation and increased mechanical properties (for instance, elongation to break, impact resistance, and tensile strength). As noted above, the 3D printing process is a powder bed fusion additive manufacturing process.

There is provided in an eighth aspect of the invention, an article obtainable by the process according to any of the first to fifth aspects of the invention. A printed article obtained by these processes exhibits enhanced ductility and toughness, and can be fabricated with a unique blend of crystal properties throughout its architecture. It is typically the case that beta polypropylene is at least partially present in the printed article. Alternatively, it may also be the case that the 3D printed article is substantially fabricated from beta polypropylene.

Unless otherwise stated, each of the integers described may be used in combination with any other integer as would be understood by the person skilled in the art. Further, although all aspects of the invention preferably “comprise” the features described in relation to that aspect, it is specifically envisaged that they may “consist” or “consist essentially” of those features outlined in the claims. In addition, all terms, unless specifically defined herein, are intended to be given their commonly understood meaning in the art.

Further, in the discussion of the invention, unless stated to the contrary, the disclosure of alternative values for the upper or lower limit of the permitted range of a parameter, is to be construed as an implied statement that each intermediate value of said parameter, lying between the smaller and greater of the alternatives, is itself also disclosed as a possible value for the parameter.

In addition, unless otherwise stated, all numerical values appearing in this application are to be understood as being modified by the term “about”.

In order that the invention may be more readily understood, it will be described further with reference to the figures and to the specific examples hereinafter.

### DESCRIPTION OF FIGURES

FIG. 1 is a schematic representation of a high speed sintering, Selective Absorption Fusion™, multi jet fusion process involving ink jet inks.

FIG. 2 is a schematic representation of a 3D process according to the invention.

FIG. 3 is a schematic representation of a 3D process according to the invention.

FIG. 4 is a schematic representation of a 3D process according to the invention.

FIG. 5 is a schematic representation of a 3D process according to the invention.

FIG. 6 illustrates a typical high speed sintering, Selective Absorption Fusion™, multi jet fusion or laser sintering processing window, whereby the polymer powder is held between its melting and crystallisation temperatures.

FIG. 7 shows experimental data for the effect of WBGII (CaₓLa₁₋ₓ(LIG1)ₘ(LIG2)ₙ) rare earth metal complex beta nucleating agent on the elongation at break (%) and charpy impact strength (kJ/m2) of an injection moulded polypropylene copolymer (far left) and injection moulded polypropylene copolymers containing long chain branching without (A) and with (B) beta nucleating agent (J. Cao et al. Polymer Testing 55 (2016) 318-327).

FIG. 8 shows a comparison between Example 1 of Table 1 (top) and Comparative Example 2 of Table 1 (bottom) following a Tensile test performed according to ISO 527; ASTM D638; or equivalent method.

FIG. 9(a) shows experimental data from Table 1 for tensile specimens prepared by powder bed fusion using polypropylene A (Comparative Example 2 and Example 1) in the presence (right) and absence (left) of calcium tetrahydrophthalate beta nucleating agent, the data comparing elongation break (EaB).

FIG. 9(b) shows experimental data from Table 2 for tensile specimens prepared by powder bed fusion using polypropylene B (Comparative Example 3, and Example 6) in the presence (right) and absence (left) of calcium tetrahydrophthalate beta nucleating agent, the data comparing elongation break (EaB).

FIG. 10 illustrates the difference in melting point of beta-nucleated polypropylene and non-nucleated or alpha-nucleated polypropylene.

FIG. 11 is a schematic representation according to the invention, whereby a lower melting beta-nucleated polypropylene is introduced in the previously sintered layer, such that said layer will re-melt more readily upon exposure to heat energy.

FIG. 12(a) is an image of larger spherulites in an injection moulded non-nucleated polypropylene copolymer (J. Cao et al. Polymer Testing 55 (2016) 318-327).

FIG. 12(b) is an image of smaller spherulites in an injection moulded beta-nucleated polypropylene copolymer (J. Cao et al. Polymer Testing 55 (2016) 318-327).

FIG. 13 is a cross-sectional image of a laser sintered nylon 12 powder showing nucleation at boundaries between powder particles (H. Zarringhalam et al. Materials Science and Engineering: A 435-436 (2006) 172-180).

FIG. 14 is an image of the particle size distribution of a dispersion of quinacridone pigment E3B dispersed in an isoparaffinic solvent suitable for the formulation of an ink. Mean volume particle size is approximately 170 nm.

### DETAILED DESCRIPTION

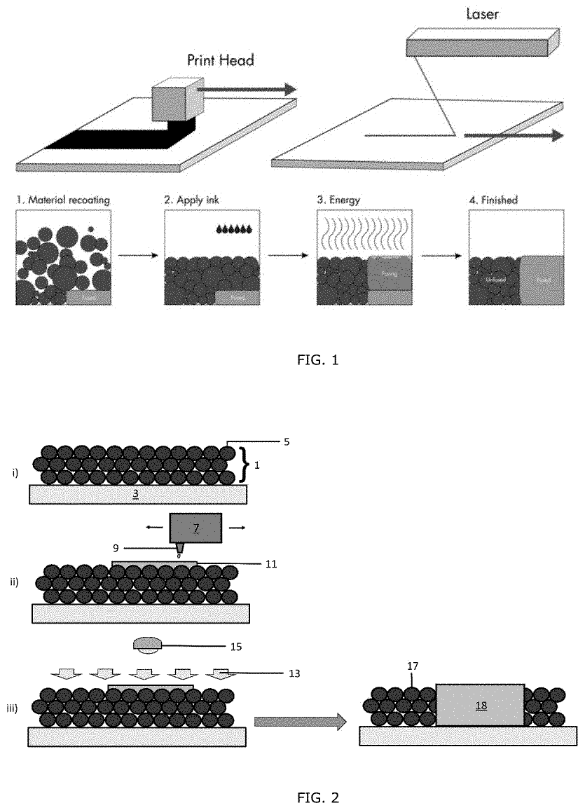

As shown in FIG. 1, high speed sintering, Selective Absorption Fusion™, multi jet fusion employs an infrared absorbing ink to sinter a polymer powder where the ink is deposited. The polymer powder is held between its melting and crystallisation temperatures ΔT (see FIG. 6) and the infrared absorbing ink allows printed sections to be melted and consolidated whilst the surrounding powder bed remains un-sintered. The final printed article can then be removed. The ink-jet ink of the high speed sintering, Selective Absorption Fusion™, multi jet fusion process represents an effective vehicle to introduce functionality and produce enhanced properties within an additive manufactured part, for instance polymer formulation is performed in-situ during the high speed sintering, Selective Absorption Fusion™, multi jet fusion manufacturing process.

FIG. 2 is a schematic representation of a 3D printing process. In step (i) a first layer of printing material 1 comprising polypropylene in non-nucleated and/or alpha-nucleated form is added to the build platform (or stage) 3. The polypropylene is provided in the form of a powder 5. In step (ii) a second layer 11 is applied in the form of an ink to at least a portion of the first layer 1. The ink comprises a beta nucleating agent and an absorber, and the ink is applied via a print-head 7 (for example, a thermal or piezoelectric print-head). In step (iii), the entire build platform 3 is irradiated with IR radiation 13 using an IR lamp 15, which selectively melts the printing material coated with the ink. This leaves behind unmelted polypropylene powder 17 and, after cooling, a region of solidified beta-polypropylene 18.

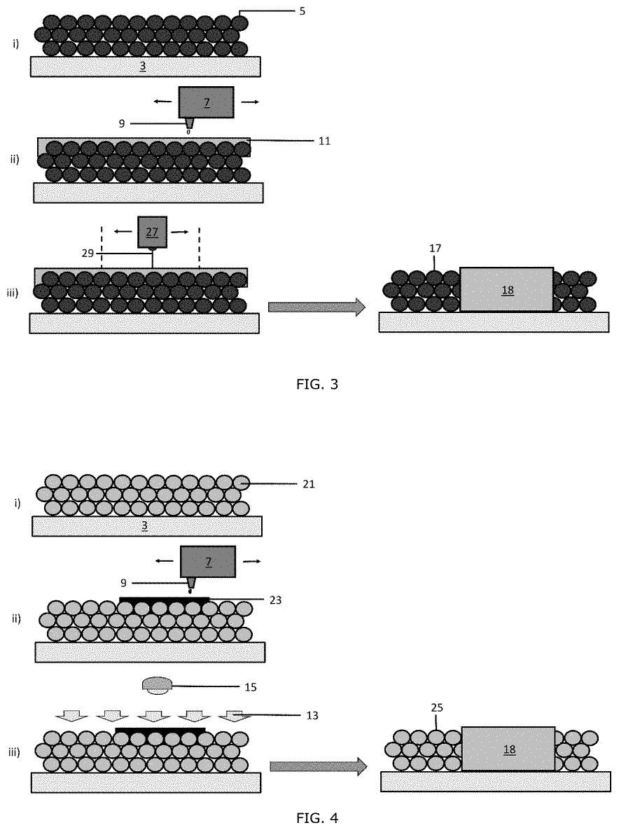

FIG. 3 is a schematic representation of a 3D printing process. In step (i) a first layer of printing material 5 comprising polypropylene in non-nucleated and/or alpha-nucleated form is added to the build platform 3. In step (ii) a second layer is applied in the form of an ink 11 to the first layer. The ink comprises a beta nucleating agent and is applied via a print-head (for example, a thermal or piezoelectric print-head). In step (iii), a specific region of the second layer is irradiated using a laser 27, such that a laser beam 29 selectively melts the printing material in a specific region. This leaves behind unmelted polypropylene powder 17 and, after cooling, a region of solidified beta-polypropylene 18.

FIG. 4 is a schematic representation of a 3D printing process. In step (i) a first layer of printing material 21 comprising polypropylene in non-nucleated and/or alpha-nucleated form is added to the build platform. A beta nucleating agent has been dispersed in the printing material 21. In step (ii) a second layer is applied in the form of an ink 23 to at least a portion of the first layer. The ink comprises an absorber and is applied via a print-head 7 (for example, a thermal or piezoelectric print-head). In step (iii), the entire build platform is irradiated with IR radiation 13 using an IR lamp 15, which selectively melts the printing material coated with the ink. This leaves behind unmelted polypropylene powder 25 and, after cooling, a region of solidified beta-polypropylene 18.

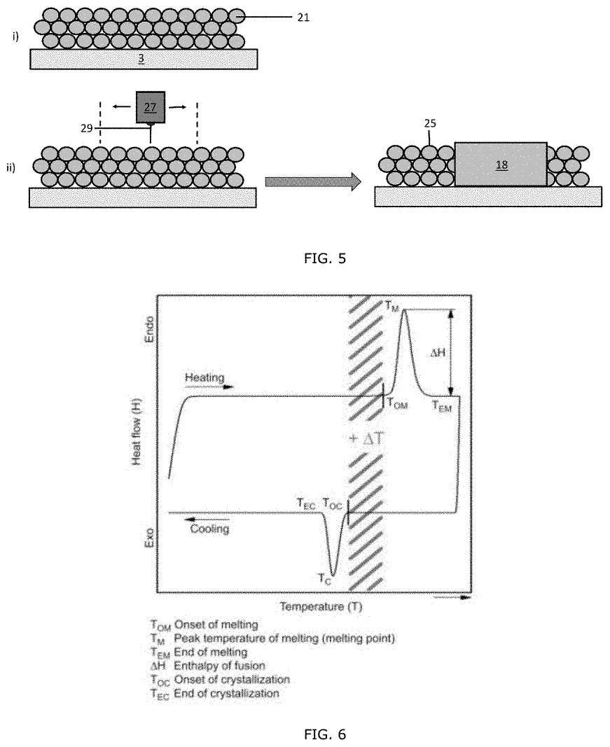

FIG. 5 is a schematic representation of a 3D printing process. In step (i) a first layer of printing material 21 comprising polypropylene in non-nucleated and/or alpha-nucleated form is added to the build platform 3. A beta nucleating agent has been dispersed in the printing material 21. In step (ii), a specific region of the first layer is irradiated using a laser beam 29 from a laser 27, which selectively melts the printing material in this specific region. This leaves behind unmelted polypropylene powder 25 and, after cooling, a region of solidified beta-polypropylene 18.

FIG. 6 illustrates a typical high speed sintering, Selective Absorption Fusion™, multi jet fusion or laser sintering processing window, whereby the polymer powder is held between its melting and crystallisation temperatures.

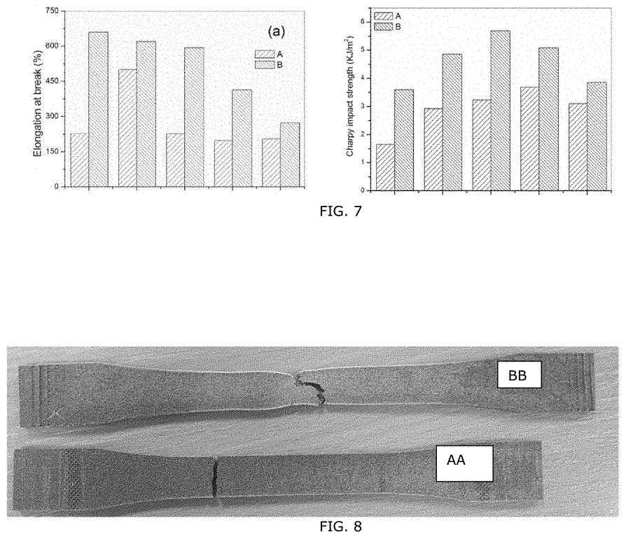

FIG. 7 shows experimental data for the effect of WBGII (CaₓLa₁₋ₓ(LIG1)ₘ(LIG2)ₙ) rare earth metal complex beta nucleating agent on the elongation at break (%) and charpy impact strength (kJ/m2) of an injection moulded polypropylene copolymer (far left) and injection moulded polypropylene copolymers containing long chain branching without (A) and with (B) beta nucleating agent (J. Cao et al. Polymer Testing 55 (2016) 318-327).

As can be seen from FIG. 8 beta nucleation significantly increases ductility, which results in necking and increased elongation at break. For instance, with FIG. 8 AA without beta nucleating agent had an average elongation at break of 32.9%, whereas BB with beta nucleating agent had an average elongation at break of 68.6%.

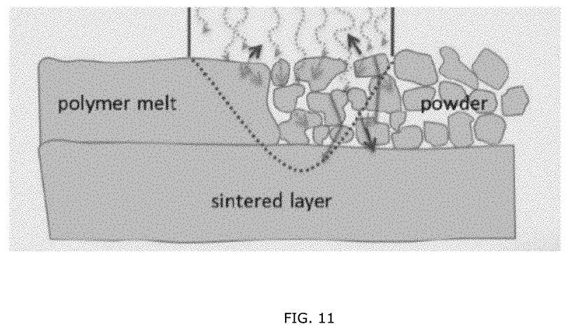

As detailed above, FIG. 10 shows the difference in melting point of beta-nucleated polypropylene and non-nucleated or alpha-nucleated polypropylene. The 3D printing processes allow for the introduction of a lower secondary melting point, resulting in production of beta-nucleated polypropylene only in printed regions of a printed article, resulting in enhanced physical and mechanical properties. Introduction of a lower melting beta-nucleated polypropylene will result in the layer re-melting more readily upon exposure to energy from a heat source (see FIG. 11), resulting in improved consolidation and increased mechanical properties.

### EXAMPLES

The invention will now be described with reference to the following non-limiting examples.

TABLE 1
Polypropylene Material A
The β-nucleator used in the examples listed in Table 1 is calcium tetrahydrophthalate.

| | β | | | Ultimate | | Notched | | HDT |
|---|---|---|---|---|---|---|---|---|
| | nucleator | | Active | Tensile | Elongation | Izod | Flexural | @ 0.45 MPa/ |
| | level in ink | Ink | Cooling | Strength | at Break | Impact | Modulus | @ 1.8 MPa |
| Example | (wt %) | Carrier | of parts | (MPa) | (%) | kJ/m² | (MPa) | (° C.) |
| Comparative | 0 | Water | No | 30 | 20 | 3.5 | Not | 100/60 |
| Example 1 | | based | | | | | tested | |
| Comparative | 0 | Mineral | No | 26.2 | 32.9 | 3.8 | 672 | 111/58.1 |
| Example 2 | | Oil base | | | | | | |
| Example 1 | 0.9 | Mineral | No | 26.5 | 68.6 | 4.2 | 700 | 113.4/59.7 |
| | | Oil base | | | | | | |
| Example 2 | 0.6 | Mineral | No | 26.4 | 50.3 | Not | Not | Not |
| | | Oil base | | | | tested | tested | tested |
| Example 3 | 0.6 | Mineral | No | 26.1 | 60.3 | Not | Not | Not |
| | | Oil base | | | | tested | tested | tested |
| Example 4 | 0.6 | Mineral | Yes | 24.7 | 75.8 | Not | Not | Not |
| | | Oil base | | | | tested | tested | tested |
| Example 5 | 1.8 | Mineral | No | 28.7 | 61.0 | Not | 593 | Not |
| | | Oil base | | | | Tested | | tested |

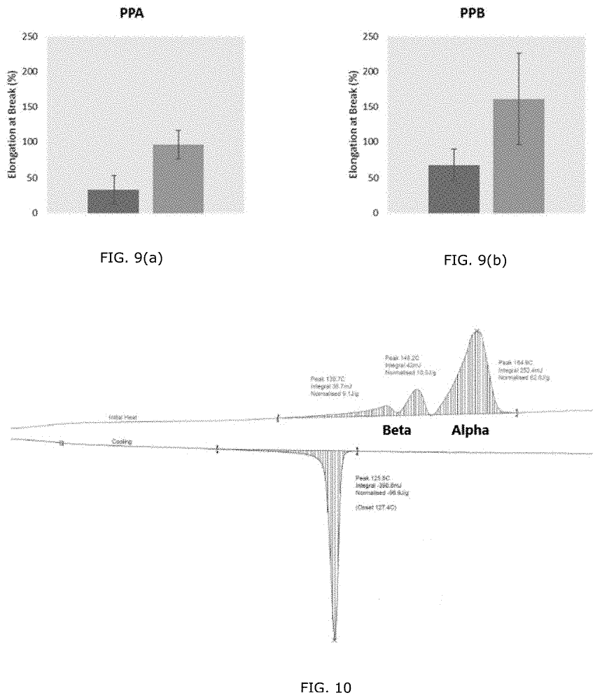

Table 1 and FIGS. 8 and 9(a) show the difference in tensile strength, elongation at break, notched Izod Impact, Flexural Modulus and Heat Deflection Temperature results between 3D printed articles according to the invention (Examples 1-5) and 3D printed articles not of the invention (Comparative Examples 1 and 2). Comparative Example 1 relates to a water-based ink containing carbon black infrared absorber prepared using high speed sintering/HP multi jet fusion, and Example 2 relates to a corresponding example employing an ink with a mineral oil base. As can be seen from the data, from incorporation of a beta nucleating agent, there is a noticeable increase in the percentage of elongation at break. For both the comparative examples and examples of the invention testing was performed as follows: tensile testing performed using type 1 specimens according to ASTM D638 or equivalent, notched Izod impact tests performed using Izod test method A and 3.2 mm specimens according to ASTM D256 or equivalent, heat deflection temperature (HDT) testing performed according to ASTM D648 or equivalent, flexural testing performed according to ASTM D790 or equivalent.

TABLE 2
Polypropylene Material B
The β-nucleator used in the examples listed in Table 2 is calcium tetrahydrophthalate.

| | β | | | Ultimate | | Notched | | HDT |
|---|---|---|---|---|---|---|---|---|
| | nucleator | | Active | Tensile | Elongation | Izod | Flexural | @ 0.45 MPa/ |
| | level in ink | Ink | Cooling | Strength | at Break | Impact | Modulus | @ 1.8 MPa |
| Example | (wt %) | Carrier | of parts | (MPa) | (%) | kJ/m² | (MPa) | (° C.) |
| Comparative | 0 | Mineral | No | 22 | 96 | Not | Not | Not |
| Example 3 | | Oil base | | | | tested | tested | tested |
| Example 6 | 0.6 | Mineral | No | 20.3 | 161 | Not | Not | Not |
| | | Oil base | | | | tested | tested | tested |

Table 2 and FIG. 9(b) show the difference in tensile strength and elongation at break results between 3D printed articles according to the invention (Example 6) and 3D printed articles not of the invention (Comparative Example 3). Comparative Example 3 relates to a mineral oil based ink containing carbon black infrared absorber. As can be seen from the data, from incorporation of a beta nucleating agent, there is a noticeable increase in the percentage of elongation at break. For both the comparative examples and examples of the invention testing was performed as follows: tensile testing performed using Type 1 specimens according to ASTM D638 or equivalent.

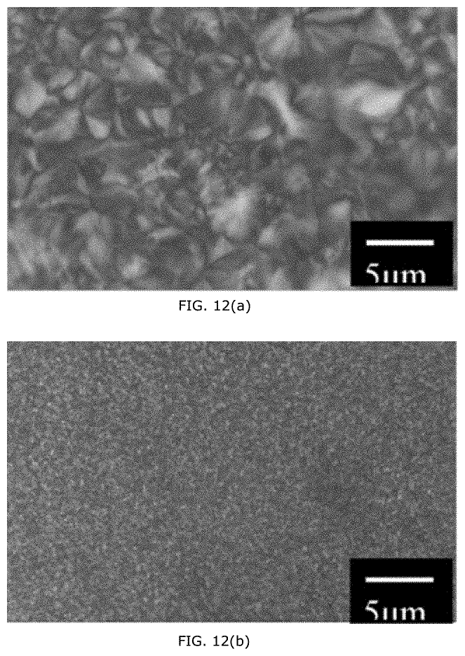

FIG. 12(a) is an image of larger spherulites in an injection moulded non-nucleated polypropylene copolymer (J. Cao et al. Polymer Testing 55 (2016) 318-327).

FIG. 12(b) is an image of smaller spherulites in an injection moulded beta-nucleated polypropylene copolymer (J. Cao et al. Polymer Testing 55 (2016) 318-327).

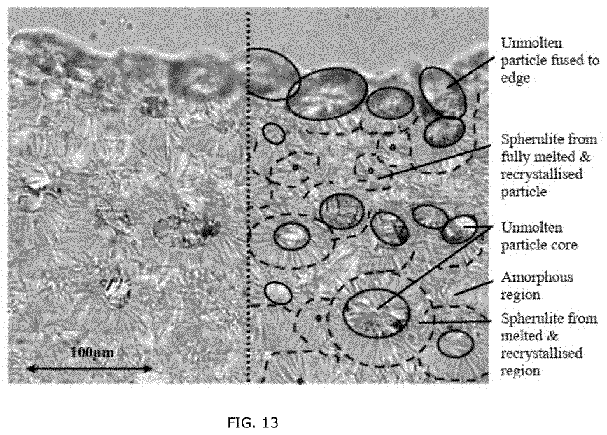

FIG. 13 is a cross-sectional image of a laser sintered nylon 12 powder showing nucleation at boundaries between powder particles (H. Zarringhalam et al. Materials Science and Engineering: A 435-436 (2006) 172-180).

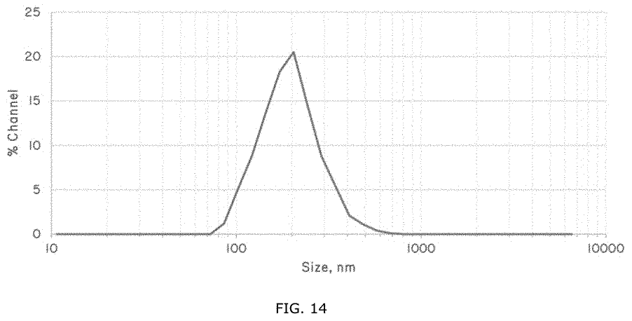

FIG. 14 is an image of the particle size distribution of a dispersion of quinacridone pigment E3B dispersed in an isoparaffinic solvent suitable for the formulation of an ink. Mean volume particle size is approximately 170 nm.

It would be appreciated that the process and apparatus of the invention are capable of being implemented in a variety of ways, only a few of which have been illustrated and described above.

1. A 3D printing process for manufacturing an article, which is a powder bed fusion additive manufacturing process, the process comprising the steps of:
(i) provision of a first layer comprising a printing material, said printing material comprising polypropylene in non-nucleated and/or alpha-nucleated form;
(ii) the optional provision of a second layer to at least a portion of the first layer;
(iii) application of heat to at least a portion of the layer or layers; and
(iv) optionally repeating steps (i) to (iii) one or more times;
wherein the first layer or the second layer comprises a beta nucleating agent, and wherein the temperature of the printing material is between the melting temperature and the crystallisation temperature of the printing material.

2. The 3D printing process of claim 1, further comprising an absorber.

3. The 3D printing process of claim 1, wherein the application of heat to the second layer comprises the application of heat from a first or a second heat source; optionally wherein the first heat source is selected from: an IR lamp; one or more resistors; or combinations thereof and/or wherein the second heat source is selected from: a laser; an electromagnetic beam; one or more resistors; or combinations thereof.

4. The 3D printing process of claim 1, wherein the second layer is present and comprises the beta nucleating agent and an absorber; and optionally wherein the application of heat to the second layer is from a first heat source.

5. The 3D printing process of claim 1, wherein the second layer is present and comprises the beta nucleating agent; and optionally wherein the application of heat is to at least a portion of the second layer from a second heat source.

6. The 3D printing process of claim 1, wherein the first layer additionally comprises the beta nucleating agent; the second layer is present and comprises an absorber; and optionally wherein the application of heat to the second layer is from a first heat source.

7. The 3D printing process of claim 1, wherein the first layer additionally comprises the beta nucleating agent; the second layer is absent; and optionally wherein the application of heat is to at least the portion of the first layer from a second heat source.

8. The 3D printing process of claim 1, wherein the first and/or second layer comprises regions of beta nucleating agent or alpha nucleating agent selectively deposited onto the printing material.

9. The 3D printing process of claim 8, wherein the selective deposition of the beta and/or alpha nucleating agents is selected from a method comprising the formation of regions comprising beta and/or alpha nucleating agent by the selective deposition of layers which comprise the nucleating agents; and/or from a method comprising the formation of regions comprising beta and/or alpha nucleating agent by the selective deposition of beta and/or alpha nucleating agent within one or more layers which also comprise regions where the beta and/or alpha nucleating agent are absent.

10. The 3D printing process of claim 1, wherein the second layer is provided directly adjacent the first layer.

11. The 3D printing process of claim 1, wherein the second layer is applied via a print-head and/or wherein the second layer is provided as an ink.

12. The 3D printing process of claim 11, wherein the volume of ink deposited in a specific area of the first layer is controlled by controlling printhead drop size or spatial coverage of drops.

13. The 3D printing process of claim 1, further comprising the additional step of recycling unmelted printing material, wherein this additional step comprises cooling the printing material.

14. The 3D printing process of claim 1, further comprising the step of preparing the printing material, wherein the beta nucleating agent is dispersed throughout the polypropylene in non-nucleated and/or alpha-nucleated form by melt extrusion.

15. The 3D printing process of claim 1, wherein the temperature of the printing material is in the range of 100° C. to 140° C., the process further comprising a step of removing the article from the printing material and optionally cooling the article.

16. The 3D printing process of claim 1, wherein the printing material further comprises one or more additives selected from: a non-propylene polymer; a compatibilizer; a stabiliser; an acid scavenger; an oxygen scavenger; a moisture scavenger; a pigment; a colourant; a fragrance; a flame retardant; an antimicrobial, antifungal or antifouling agent; an antistatic agent; a magnetic agent; an electromagnetic shielding agent; a radio-opaque agent; a conductive agent; a cross-linking agent; a foaming agent; a flow aid; a reinforcing filler; a plasticiser; or combinations thereof.

17. An ink for 3D printing, wherein the 3D printing process is a powder bed fusion additive manufacturing process, the ink comprising a beta nucleating agent and optionally polypropylene.

18. The ink of claim 17, wherein the beta nucleating agent is provided as particles and/or the ink is selected from a liquid; or a solid in the form of a powder, granules, or pellets, or combinations thereof.

19. The ink of claim 18, wherein the ink comprises a solvent selected from an oleophobic liquid, such as water and/or an oleophilic liquid, such as a hydrocarbon.

20. The ink of claim 17, further comprising at least one additive selected from: an absorber; a stabiliser; an acid scavenger; a reinforcing filler; a compatibilizer; an oxygen scavenger; a moisture scavenger; a pigment; a colourant; a dispersant; a plasticiser; a fragrance; an alpha-nucleating agent; a flame retardant; an antimicrobial, antifungal or antifouling agent; an antistatic agent; a magnetic agent; an electromagnetic shielding agent; a radio-opaque agent; a conductive agent; a cross-linking agent; a foaming agent; an adjuvant to any of the above; or combinations thereof.

21. An article obtainable by the process according to claim 1.
